(19) United States
(12) Patent Application Publication
(10) Pub. No.: US 2020/0129819 A1
(43) Pub. Date: Apr. 30, 2020

(54) SYSTEM DEVICES AND METHODS FOR SPORTS BALL WITH IMAGE

(71) Applicant: Huawei Technologies Co., Ltd., Shenzhen (CN)

(72) Inventor: Jacob Hazellief, Sevierville, TN (US)

(21) Appl. No.: 16/727,495

(22) Filed: Dec. 26, 2019

Related U.S. Application Data
(60) Provisional application No. 62/479,090, filed on Mar. 30, 2017.

(51) Int. Cl. A63B 45/02; A63B 43/00; B41F 17/34; G06F 3/12

(52) U.S. Cl. CPC A63B 45/02; G06F 3/1285; B41F 17/34; A63B 43/008

(57) ABSTRACT

Disclosed herein is a sporting ball with a specific image printed on the sporting ball. The image is generated, selected, or captured by a user, which triggers a process for printing the image onto the ball. Further disclosed are systems and methods for printing and delivering the sporting ball with the image. The image may be an image of the user, a favorite sports athlete, or a celebrity. Certain preferred embodiments utilize a basketball, a soccer ball, or a football. However, alternative embodiments may include any type of sporting ball. The image may be captured by numerous means recognizable by those skilled in the art, including but not limited to a computing device, a cellular phone, a tablet, a web cam, a digital cam, and other traditional non-digital cameras.

### CROSS REFERENCE TO RELATED APPLICATIONS

This application claims priority under 35 U.S.C. § 119 to U.S. Patent Application No. 62/479,090, filed Dec. 26, 2018, and entitled “System Devices And Methods For Sports Ball With Image.” The entire contents of the above-identified application are incorporated herein by reference.

### TECHNICAL FIELD

The invention relates to sporting equipment and accessories.

### BACKGROUND

Sports are very popular worldwide, basketball and soccer in particular, as well as football. What is lacking in the prior art is the ability to print a user's image, or a preferred selected image on their favorite sports ball of choice. Thus, there remains a considerable need for systems, devices, and methods to enable a user to select an image easily and have it printed on their sporting ball of choice.

### SUMMARY

Disclosed herein is a sporting ball with a specific image printed on the sporting ball. The image is generated, selected, or captured by a user, which triggers a process for printing the image onto the sporting ball. Further disclosed are systems and methods for printing and delivering the sporting ball with the image. The image may be that of the user, a favorite sports athlete, or a celebrity. Certain preferred embodiments utilize a basketball, a soccer ball, or a football. However, alternative embodiments may include any type of sporting ball. This includes but is not limited to soccer balls, basketballs, footballs, baseballs, tennis balls, racquetballs, dodge balls, ping pong balls, and many others. Any sporting ball with an approximately spherical contour may be utilized with the current invention. The image may be captured by numerous means recognizable by those skilled in the art, including but not limited to a computing device, a cellular phone, a tablet, a web cam, a digital cam, and other traditional non-digital cameras.

### BRIEF DESCRIPTION OF THE DRAWINGS

FIG. 1 illustrates exemplary embodiments for selected images for the ball's surface.

FIG. 2 shows how a user may snap a selfie (210), send that image to localized software running a mobile device or to a remote computer for processing (220), and print the image on a ball's surface (230).

FIG. 3 is a block diagram depicting a computing machine and a module, in accordance with certain examples.

### DETAILED DESCRIPTION

Overview

The characteristics and utilities of the present invention described in this overview and the detailed description below are not all inclusive. Many additional features and advantages will be apparent to one of ordinary skill in the art given the following description. The more important features of the invention are outline broadly, such that the detailed description that follows may be better understood, and such that the present contribution to the art may be better appreciated. Disclosed herein is a sporting ball with a specific image printed on the sporting ball.

An image is generated, selected, or captured by a user, which triggers a process for printing the image onto the sporting ball. Further disclosed are systems and methods for printing and delivering the sporting ball with the image. The image may be that of the user, a favorite sports athlete, or a celebrity. Certain embodiments utilize a basketball, a soccer ball, or a football. However, alternative embodiments may include any type of sporting ball. This includes but is not limited to soccer balls, basketballs, footballs, baseballs, tennis balls, racquetballs, dodge balls, ping pong balls, and many others. Any sporting ball with an approximately spherical contour is appropriate with the current invention. Across the various embodiments, the sporting ball may come in multiple options including, team colors, team logos, player numbers, player signatures, player images, etc.

The sporting ball may then be sold for play or as a collectable. The image may be captured by the numerous means recognizable by those skilled in the art, including but not limited to a computing device, a cellular phone, a tablet, a web cam, a digital cam, and other traditional non-digital cameras. After capturing the image, the image may be processed and printed onto a sporting ball by many different methods, as would be recognized by those skilled in the art. The printing step may utilize specialized printers capable of printing on a curved surface, as will be recognized by those skilled in the art.

In one embodiment, the image processing occurs on an image capture device. In other embodiments, the image is sent to a second computing device over a network, whereby the image is processed and printing instructions are carried out. The end result is a sporting ball with a unique image of the user, or selected individual. Digital images of the desired image shown on various items including sporting balls may be shown as a preview for the user. For example, the user may take a picture with a cellular device, which is then processed by a mobile app with display previews of the image printed on various sporting balls or a ball type selected by the user within the app. In other embodiments, the image may be sent over email or other message networks, and an email may be returned to the user's device showing a series of previews of the image on the sporting ball or balls. After the image has been printed onto the sporting ball, the sporting ball may be delivered to the user by many different means.

In certain embodiments presented herein, the entire system and process may be automated such that a picture is snapped through an app and the desired ball is automatically sent to the user. In addition to capturing an original image, the user may select a photo from their own collection or album. Further the software, mobile app, or desktop app may connect to a database containing a collection of usable images for the sporting ball surface. In one embodiment, desktop software or a mobile app will prompt the user to select the sporting ball of interest, i.e., a basketball, soccer balls, or other sporting ball, and the required printing and size specifications are preloaded into the software to automatically fit the selected sporting ball. Software functions across the various embodiments may be carried out on a personal device such as a cell phone, a tablet, a personal desktop computer, or a remote device, whereby the image is sent to the remote device over a network.

These and other aspects, objects, features, and advantages of the example embodiments will become apparent to those having ordinary skill in the art upon consideration of the following detailed description of illustrated example embodiments.

### Example Embodiments

Turning now to the drawings, in which like numerals represent like (but not necessarily identical) elements throughout the figures, example embodiments are described in detail.

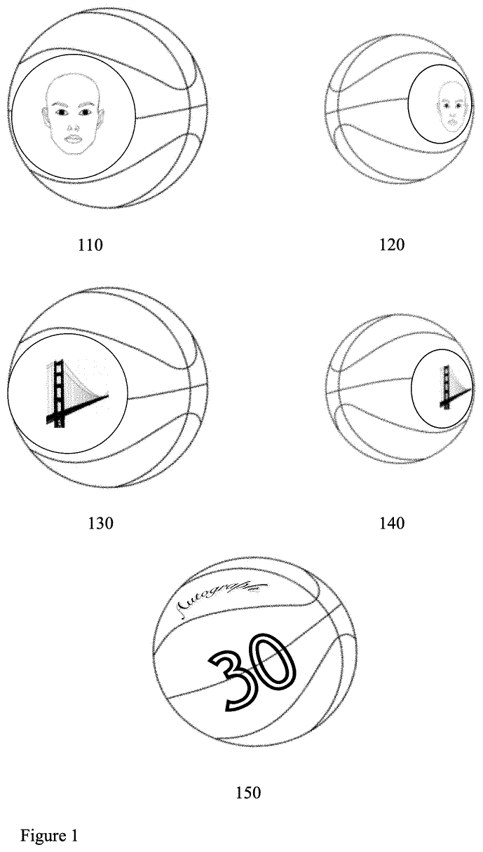

In FIG. 1, exemplary embodiments are shown for selected images for the sporting balls surface. At 110, a basketball with a celebrity image chosen. At 120, the same image and the ball are depicted from a slightly different angle. At 130, a landmark image is illustrated on a ball. At 140, the same image is illustrated from a different angle view. At 150, another example of a ball is illustrated decorated with a number and signature. These are examples only and do not comprise an exhaustive list.

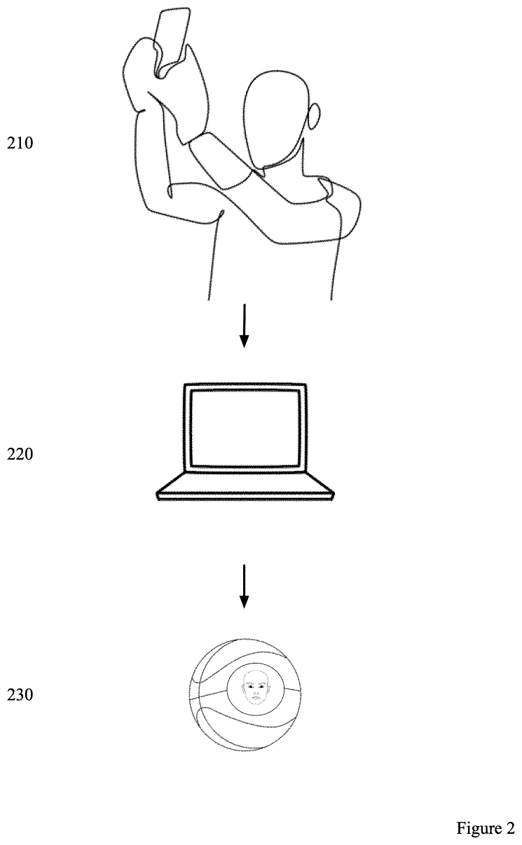

FIG. 2 shows how a user may snap a selfie (210), send that image to either localized software running the mobile device or a remote computer for processing (220), which then carries out the instructions for printing and producing the ball (230). The computing device depicted at 220 may be any computing device local or remote which may process a captured image and prepare the specification for printing onto the ball. The computing device depicted at 220 may represent computing power and software running on either the image capture device itself, such as a cell phone, a smart phone, or a tablet for example. The computing device depicted at 220 may also, in further embodiments, be a desktop computer operating remotely which receives the image from the image capture device and processes it according to the needed printing specifications. The remote computer or image capture device, may then send the user a set of preview images to be selected for final printing.

For the purposes of describing and defining the present invention it is noted that the use of relative terms such as “substantially”, “generally”, “approximately” and the like, are utilized herein to represent an inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

Exemplary embodiments of the present invention are described above. No element, act, or instruction used in this description should be construed as important, necessary, critical, or essential to the invention unless explicitly described as such. Although only a few of the exemplary embodiments have been described in detail herein, those skilled in the art will readily appreciate that many modifications are possible in each of the exemplary embodiments without materially departing from the novel teachings and advantages of this invention. Accordingly, all such modifications are intended to be included within the scope of this invention.

The phrase “in one embodiment” is used repeatedly. The phrase generally does not refer to the same embodiment; however, the phrase may refer to the same embodiment. The terms “comprising,” “having,” and “including” are synonymous, unless the context dictates otherwise. The following illustrations of various embodiments use particular terms by way of example to describe the various embodiments, but this should be construed to encompass and provide for terms such as “method,” “routine,” and the like.

Various aspects of the illustrative embodiments will be described using terms commonly employed by those skilled in the art to convey the substance of their work to others skilled in the art. However, it will be apparent to those skilled in the art that the embodiments described herein may be practiced with only some of the described aspects. For purposes of explanation, specific numbers, materials, and configurations are set forth in order to provide a thorough understanding of the illustrative embodiments. However, it will be apparent to one skilled in the art that the embodiments described herein may be practiced without the specific details. In other instances, well-known features are omitted or simplified in order not to obscure the illustrative embodiments.

The characteristics and utilities of the present invention described in this summary and the detailed description below are not all inclusive. Many additional features and advantages will be apparent to one of ordinary skill in the art given the following description. There has thus been outlined, rather broadly, the more important features of the invention in order that the detailed description that follows may be better understood, and in order that the present contribution to the art may be better appreciated.

In this respect, by explaining at least one embodiment of the invention in detail, it is to be understood that the invention is not limited in its application to the details of construction and to the arrangements of the components set forth in the description. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception upon which this disclosure is based may readily be utilized as a basis for the design of other structures, methods, and systems for carrying out the several purposes of the present invention. It is important, therefore, that the description be regarded as including such equivalent constructions insofar as they do not depart from the spirit and scope of the present invention.

Further, the purpose of the abstract is to enable the U.S. Patent and Trademark Office, the public, and especially the scientists, the engineers, and practitioners in the art who are not familiar with patent or legal terms or phraseology, to determine quickly, from a cursory inspection, the nature and essence of the technical disclosure of the application. The abstract is neither intended to define the invention of the application, nor is it intended to be limiting as to the scope of the invention in any way.

### Other Examples

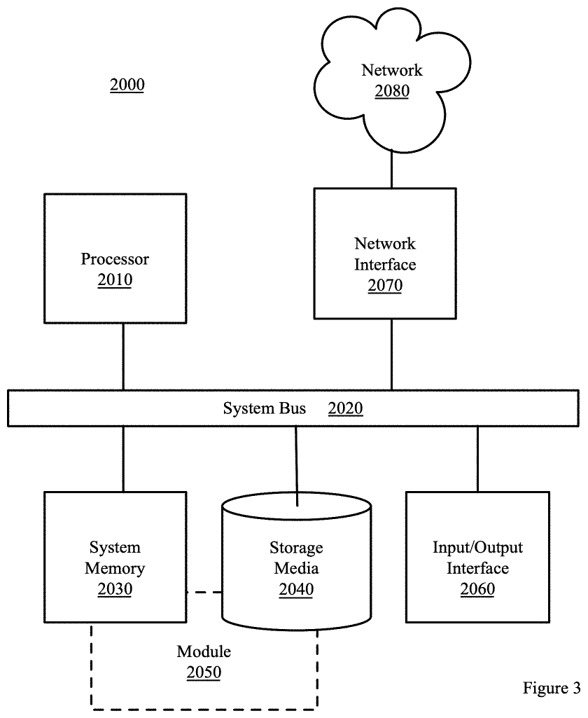

FIG. 3 depicts a computing machine 2000 and a module 2050 in accordance with certain examples. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a router or other network node, a vehicular information system, one or more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain examples, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (“WAN”), local area networks (“LAN”), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to certain examples, any of the processor 2010, the other elements of the computing machine 2000, or the various peripherals discussed herein may be integrated into a single device such as a system on chip (“SOC”), system on package (“SOP”), or ASIC device.

Examples may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing examples in computer programming, and the examples should not be construed as limited to any one set of computer program instructions. Further, a skilled programmer would be able to write such a computer program to implement an example of the disclosed examples based on the appended flow charts and associated description in the application text. Therefore, disclosure of a particular set of program code instructions is not considered necessary for an adequate understanding of how to make and use examples. Further, those skilled in the art will appreciate that one or more aspects of examples described herein may be performed by hardware, software, or a combination thereof, as may be embodied in one or more computing systems. Moreover, any reference to an act being performed by a computer should not be construed as being performed by a single computer as more than one computer may perform the act.

The examples described herein can be used with computer hardware and software that perform the methods and processing functions described herein. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (“FPGA”), etc.

The example systems, methods, and acts described in the examples presented previously are illustrative, and, in alternative examples, certain acts can be performed in a different order, in parallel with one another, omitted entirely, and/or combined between different examples, and/or certain additional acts can be performed, without departing from the scope and spirit of various examples. Accordingly, such alternative examples are included in the scope of the following claims, which are to be accorded the broadest interpretation so as to encompass such alternate examples.

Although specific examples have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the examples, in addition to those described above, can be made by a person of ordinary skill in the art, having the benefit of the present disclosure, without departing from the spirit and scope of examples defined in the following claims, the scope of which is to be accorded the broadest interpretation so as to encompass such modifications and equivalent structures.

What is claimed is:

1. A sporting ball with an image printed on a surface of the sporting ball, wherein the image is one or more of a user of the sporting ball, a celebrity, a sports trademark, a logo, a number, or a famous landmark.

2. The sporting ball of claim 1, wherein the sporting ball with the image is created by:
capturing, by a computing device, the image;
processing, by the computing device, the image; and
printing, by the computing device, the image on the sporting ball.

3. The sporting ball of claim 2, wherein the image is processed by a mobile app operating on the computing device.

4. The sporting ball of claim 2, wherein the processing is done on a remote computing device which the computing device sends over a network to the remote computing device to adapt the image to specifications to print onto a certain type of sporting ball.

5. The sporting ball of claim 1, wherein the sporting ball is a basketball, a soccer ball, or a football.

6. A system to produce a ball with an image printed on a surface of the ball, comprising:
a camera;
a computing device;
a printer; and
a ball, wherein the system operates to print an image on a surface of the ball.

7. The system of claim 6, further comprising:
capturing, by the computing device, an image from the camera;
processing, by the computing device, the image; and
transmitting, by the computing device, the image to the printer with the ball.

8. The system of claim 7, wherein the image is processed by a mobile app operating on the computing device.

9. The system of claim 7, wherein the processing is done on a remote computing device, wherein the computing device sends a communication over a network to the remote computing device to adapt the image to specifications to print onto a certain type of ball.

10. The system of claim 6, wherein the ball is a basketball, a soccer ball, or a football.

11. The system of claim 6, wherein the image is one or more of a user of the ball, a celebrity, a sports trademark, a logo, a number, or a famous landmark.
